(19) United States
(12) Patent Application Publication
(10) Pub. No.: US 2006/0204136 A1
(43) Pub. Date: Sep. 14, 2006

(54) System and method for aligning sub-images projected on screen

(75) Inventor: Chang-Hung Lee, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/373,590

(22) Filed: Mar. 10, 2006

(30) Foreign Application Priority Data
Mar. 11, 2005 (TW) 094107554

(51) Int. Cl. G06K 9/32

(52) U.S. Cl. 382/294

(57) ABSTRACT

A system for projecting an image onto a screen divided into N regions is provided, wherein N is an integer larger than 1. The system according to a preferred embodiment of the invention includes a processing apparatus, N projecting apparatuses and at least one sensing device. The processing apparatus divides the image into N sub-images. The N projecting apparatuses respectively receive the N sub-images and project the received sub-images onto the N regions of the screen. The at least one sensing device senses the projected sub-images, and transmits the sensed sub-images to the processing apparatus. The processing apparatus further calculates alignment differences among the sensed sub-images, and adjusts the projected sub-images on the screen according to the alignment differences to eliminate the alignment differences.

### BACKGROUND OF THE INVENTION

1. Field of the Invention

This invention relates to a projecting system. More specifically, this invention relates to a projecting system for projecting an image onto a screen divided into N regions.

2. Description of the Prior Art

Because of the mighty advancement of recent projecting technologies and descending prices, projectors with high resolution and large projection area have become necessities for providing visual images in business briefings, conferences, educational trainings, and even home entertainments. Therefore, high image quality, high brightness, small volume, fair price, and good services are all important indices for consumers when buying projectors.

At the present day, the biggest size of a projected image can be provided by a single projector is about 200 inches. However, larger image sizes (for example, several meters) are sometimes required. An image of such a large size can not be projected by a single projector; but must be assembled by sub-images simultaneously projected by several individual projectors. Therefore, there are inevitably a lot of sub-images alignment issues that decrease the quality of images projected by a projecting system.

Accordingly, the main purpose of this invention is providing a projecting system to overcome aforementioned problems.

### SUMMARY OF THE INVENTION

The main purpose of the invention is to provide a projecting system for projecting a plurality of sub-images onto a screen divided into N regions, and adjusting the projected sub-images on the screen to eliminate alignment differences.

The projecting system in accordance with the first preferred embodiment of this invention projects an image onto a screen divided into N regions, wherein N is an integer larger than 1. The projecting system includes a processing apparatus, N projecting apparatuses, and at least one sensing device. The processing apparatus divides the image into N sub-images. The N projecting apparatuses receive the N sub-images and project the received sub-images onto the N regions of the screen. The at least one sensing device senses the projected N sub-images and transmits the sensed sub-images to the processing apparatus. The processing apparatus further calculates a plurality of alignment differences among the sensed sub-images, and adjusts the projected sub-images on the screen according to the alignment differences to eliminate the alignment differences.

The projecting system in accordance with the second preferred embodiment of the invention sends a first sub-image to a first projecting apparatus and a second sub-image to a second projecting apparatus. The first projecting apparatus and the second projecting apparatus respectively project the first sub-image and the second sub-image onto a screen as a first projected sub-image and a second projected sub-image. The projecting system includes a sensing device and a processing apparatus. The sensing device senses the first projected sub-image and the second projected sub-image as a first sensed sub-image and a second sensed sub-image. The processing apparatus receives an original image and divide the original image into the first sub-image and the second sub-image. The processing apparatus receives the first sensed sub-image and the second sensed sub-image from the sensing device, and calculates an alignment difference between the first sensed sub-image and the second sub-image. The processing apparatus also adjusts the first projected sub-image and the second projected sub-image in accordance with the alignment difference to eliminate the alignment difference.

The advantage and spirit of the invention may be understood by the following recitations together with the appended drawings.

### BRIEF DESCRIPTION OF THE APPENDED DRAWINGS

FIG. 1 shows the projecting system in accordance with the first preferred embodiment of the invention.

FIG. 2A through FIG. 2D respectively show several kinds of alignment differences.

FIG. 3 shows the example of using edge mark images.

FIG. 4 shows the flow chart of the projecting method according to this invention.

FIG. 5 shows the projecting system according to the second preferred embodiment of this invention.

### DETAILED DESCRIPTION OF THE INVENTION

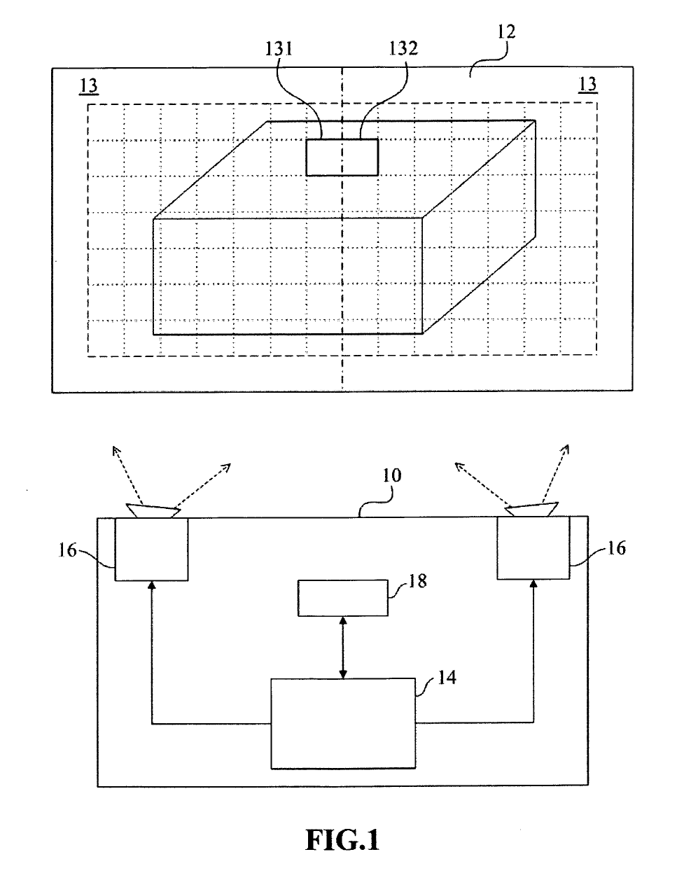

Please refer to FIG. 1. FIG. 1 shows the projecting system 10 in accordance with the first preferred embodiment of the invention. The projecting system 10 projects an image onto a screen 12 divided into N regions 13, wherein N is an integer larger than 1.

As shown in FIG. 1, the projecting system 10 includes a processing apparatus 14, N projecting apparatuses 16, and at least one sensing device 18. As shown in FIG. 1, N equals 2. That is to say, the screen 12 is divided into two regions 13, and the processing apparatus 14 includes two projecting apparatuses. Also as shown in FIG. 1, only one sensing device 18 is drawn to illustrate the first preferred embodiment of the invention.

The processing apparatus 14 divides an input image into N sub-images. Each sub-image corresponds to one region 13. As in the aforementioned example, the input image is divided into two sub-images in the following statement.

The two projecting apparatuses 16 respectively receive the two sub-images, and project the received sub-images onto the corresponding regions 13 of the screen 12.

The sensing device 18 senses the projected sub-images on the screen 12, and transmits the sensed sub-images to the processing apparatus 14.

The processing apparatus 14 further calculates the alignment differences between the two sub-images. The processing apparatus 14 also adjusts the projected sub-images on the screen 12 based on the plurality of alignment differences to eliminate the alignment differences. In one preferred embodiment, the alignment differences could be differences of position, size, or brightness between the sub-image.

Furthermore, the processing apparatus 14 selects any one projecting apparatus 16 to adjust the positions, sizes, keystones, and brightness of the sub-images projected on the screen 12. Hence, the plurality of alignment differences can be eliminated such that the image is adjusted.

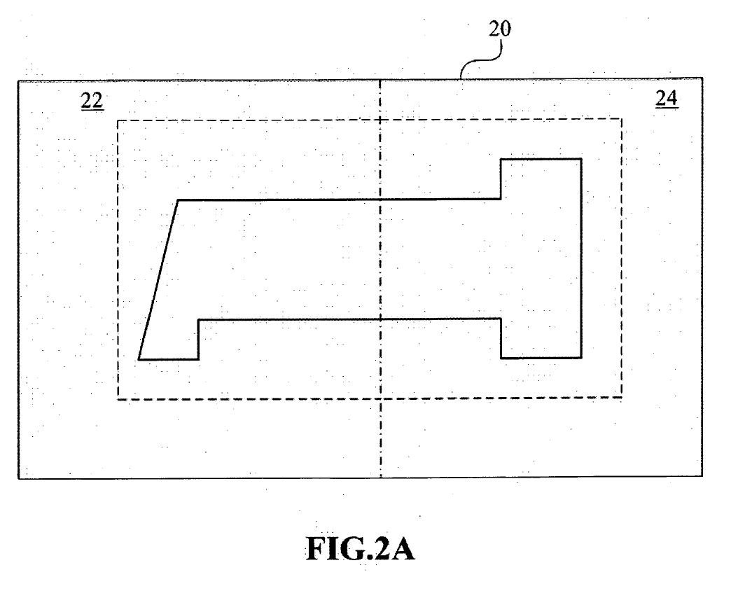

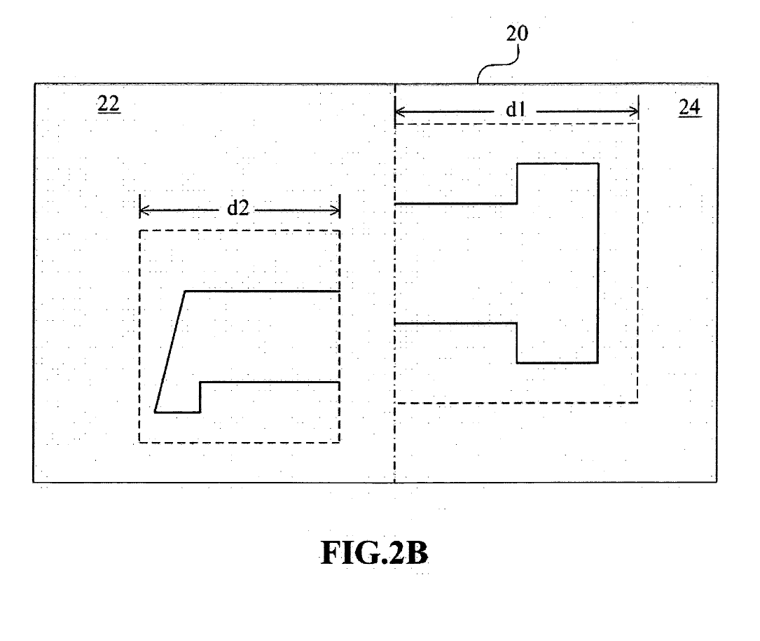

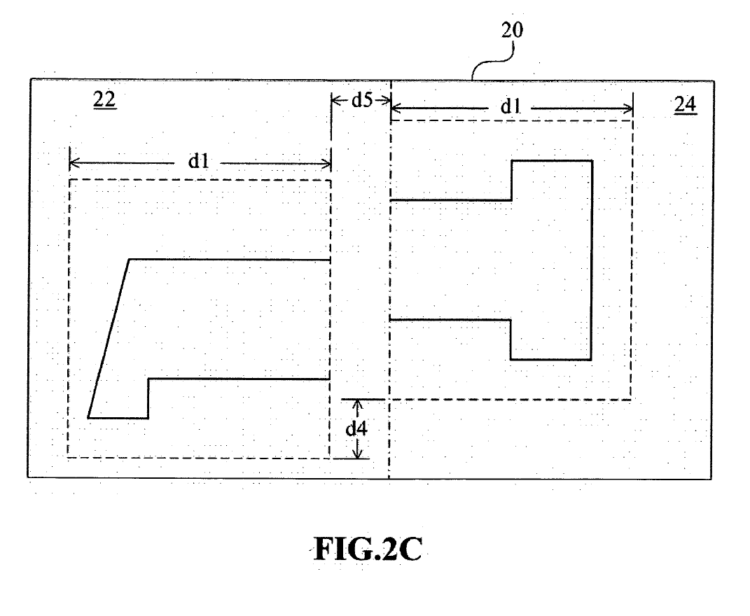

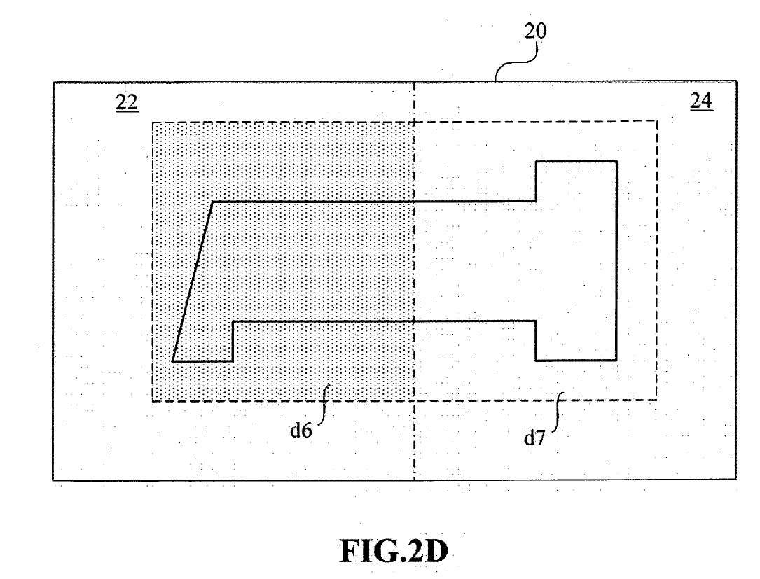

The following statements will show several examples for explaining the types of alignment differences and the eliminating methods thereof. Please also refer to FIG. 2A through FIG. 2D and their corresponding descriptions. FIG. 2A through FIG. 2D show the sub-images projected by the projecting system (not shown in the figures) according to the first preferred embodiment of the invention. The projecting system respectively project two sub-images onto the two regions 22 and 24 of a screen 20. FIG. 2A shows the sub-images expected to be respectively projected onto the region 22 and the region 24. The sub-images in FIG. 2A further make up a complete image as demanded without any alignment differences. FIG. 2B through 2D respectively show the sub-images projected on the region 22 and the region 24, with different types of alignment differences between the sub-images.

As shown in FIG. 2B, the size of the sub-image projected on the region 22 is smaller than original expectations, and the projected position is deviated from the expected position. Therefore, the projecting system according to the first preferred embodiment of the invention calculates an alignment difference of size ratio between the two sub-images d3=d2/d1 and immediately adjusts the sub-image projected to the region 22 based on the alignment difference d3. FIG. 2C shows the adjusted sub-image projected on the region 22. Nevertheless, as shown in FIG. 2C, there still exists a vertical distance d4 and a horizontal distance d5 between the sub-images respectively projected on the region 22 and the region 24. Therefore, the projecting system according to the first preferred embodiment of the invention calculates an alignment difference of positions between the sub-images and immediately adjusts the sub-image projected to the region 22 based on the alignment differences (d4 and d5). Hence, as shown in FIG. 2A, the sub-images with eliminated alignment differences is completed.

In addition, as shown in FIG. 2D, the two sub-images respectively projected onto the region 22 and the region 24 of the screen 20 have individual brightness d6 and d7. Therefore, the projecting system according to the first preferred embodiment of the invention calculates an alignment difference of brightness between the sub-images d8=(d7−d6) and immediately adjusts the sub-image projected on the region 22 according to the alignment difference d8 to eliminate the alignment difference between the sub-images.

In one preferred embodiment also as that shown in FIG. 1, the processing apparatus 14 further blends each of the sub-images with an alignment image, and respectively outputs the two blended images to the two projecting apparatus 16. The projecting apparatus 16 simultaneously projects the alignment images and the sub-image onto the screen 20. The alignment images projected on the screen are also sensed by the sensing device and then are sent to the processing apparatus 14. Via the sensed alignment images, the processing apparatus 14 can calculate the alignment differences more easily and precisely. For example, as shown in FIG. 1, the shapes of the sub-images can be adjusted according to the size of the two adjacent meshes 131, 132. The two sub-images can also be jointed more precisely according to the aligning of adjacent meshes. As shown in FIG. 1, the alignment image is a mesh image with the same size as that of each of the two sub-images.

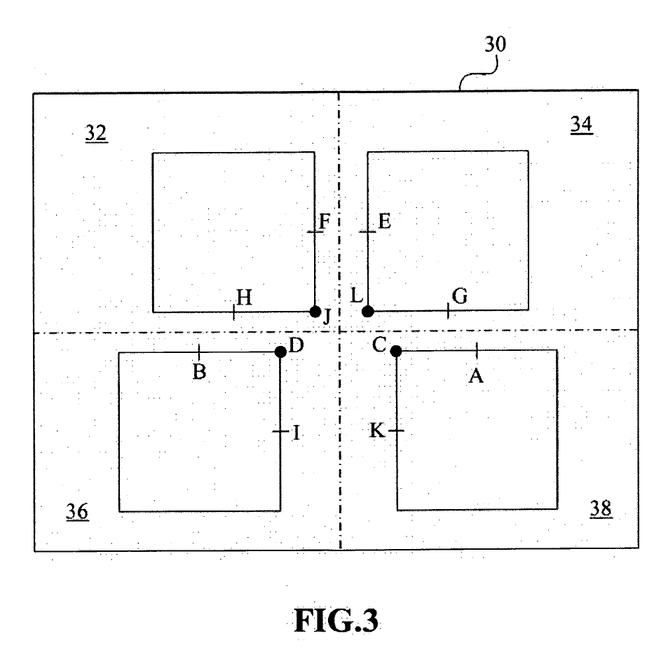

In another preferred embodiment, the alignment image blended with each of the sub-images is an edge mark image. As shown in FIG. 3, according to the first preferred embodiment of the invention, the projecting system (not shown in the figures) respectively projects the four sub-images onto four regions of a screen 30. Each of the four sub-images has at least one edge being blended with an edge mark image. For example, as shown in FIG. 3, edges of the sub-images projected onto the regions (32, 34, 36, 38) are respectively blended with the edge mark images (F′J′H), (E′L′G), (B′D′I), and (A′C′K).

In actual applications, the projecting system can practice the aligning job before the sub-images are formally projected. According to this invention, the projecting system can also formally project and adjust the projected sub-image at the same time by projecting the alignment images in invisible rays. Since the alignment images projected in invisible rays are invisible to users who watch the images on the screen 12, the contents and qualities of the projected images seen by users are not affected.

In one embodiment, the sensing device 18, the processing apparatus 14 and the projecting apparatus 16 can be integrated together. In this embodiment, the sensing device senses the two projected sub-images through the lens of the projecting apparatus, and sends the sensed sub-images to the processing apparatus for subsequent adjustment of the images. In this embodiment, the projecting apparatus must setup a mechanism for communication and server-client control. In another embodiment, the sensing device and the processing apparatus can also be setup independently, and coupled to the independent projecting apparatuses. In this embodiment, the sensing device directly senses the two images projected by the projecting apparatus 16, and sends the images to the processing apparatus. Both of the embodiments above can achieve the function of sensing the sub-images projected on the screen and the function of sending the plurality of sensed sub-images to the processing apparatus for subsequent processing.

In one embodiment, the alignment images are blended with the sub-images in the projecting apparatus 16. In the other embodiment, the alignment images are blended with the sub-images in the processing apparatus 14.

In one embodiment, the projecting apparatus adjusts the projected sub-images in accordance with a plurality of commands transmitted by the processing apparatus 14. In the embodiment, the processing apparatus 14 calculates a plurality of alignment differences and immediately commands the projecting apparatus to adjust the sub-images projected by the projecting apparatus itself. The alignment differences between the sub-images can be eliminated by adjusting the projected sub-images.

In the other embodiment, the processing apparatus 14 adjusts the two sub-images and sends the adjusted sub-images to the two projecting apparatuses 16. In this embodiment, after calculating a plurality of alignment differences, the processing apparatus 14 adjusts the two sub-images in accordance with the plurality of alignment differences and then sends the adjusted sub-images to the two projecting apparatuses 16 for projecting. In this embodiment, the sub-images then projected by the two projecting apparatuses onto the screen make up a complete image, wherein the plurality of alignment differences are eliminated.

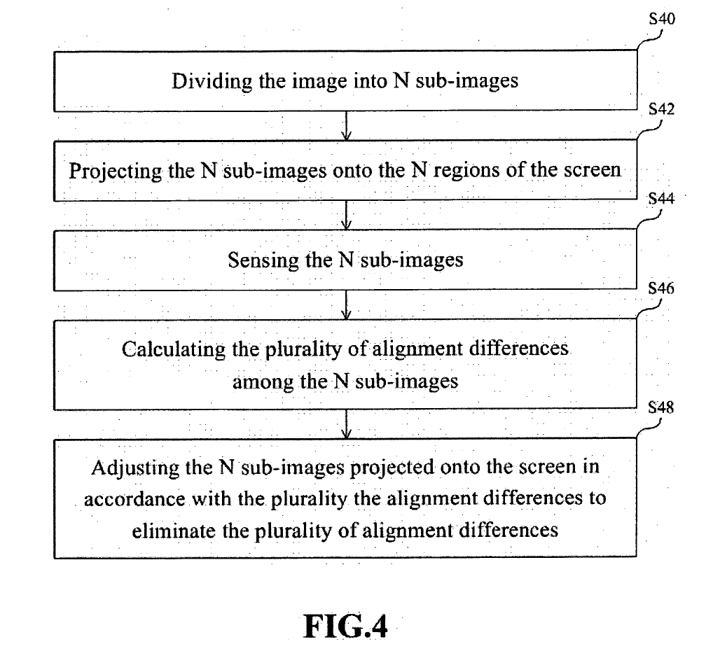

Please refer to the FIG. 4. FIG. 4 shows the flow chart of the projecting method according to this invention. As shown in FIG. 4, this invention provides a projecting method for projecting an image onto a screen divided into N regions, wherein N is an integer larger than 1. In accordance with the projecting method of the invention, step S40 is executed first to divide the image into N sub-images. Then step S42 is executed to project the N sub-images onto the N regions of the screen.

Subsequently, step S44 is executed to sense the N sub-images. Then step S46 is executed to calculate the plurality of alignment differences among the N sub-images. At last, step S48 is executed to adjust the N sub-images projected onto the screen in accordance with the plurality the alignment differences to eliminate the plurality of alignment differences.

In one embodiment, step S40 also respectively blends each of the sub-images with an alignment image. In one embodiment, the alignment image is projected by an invisible ray.

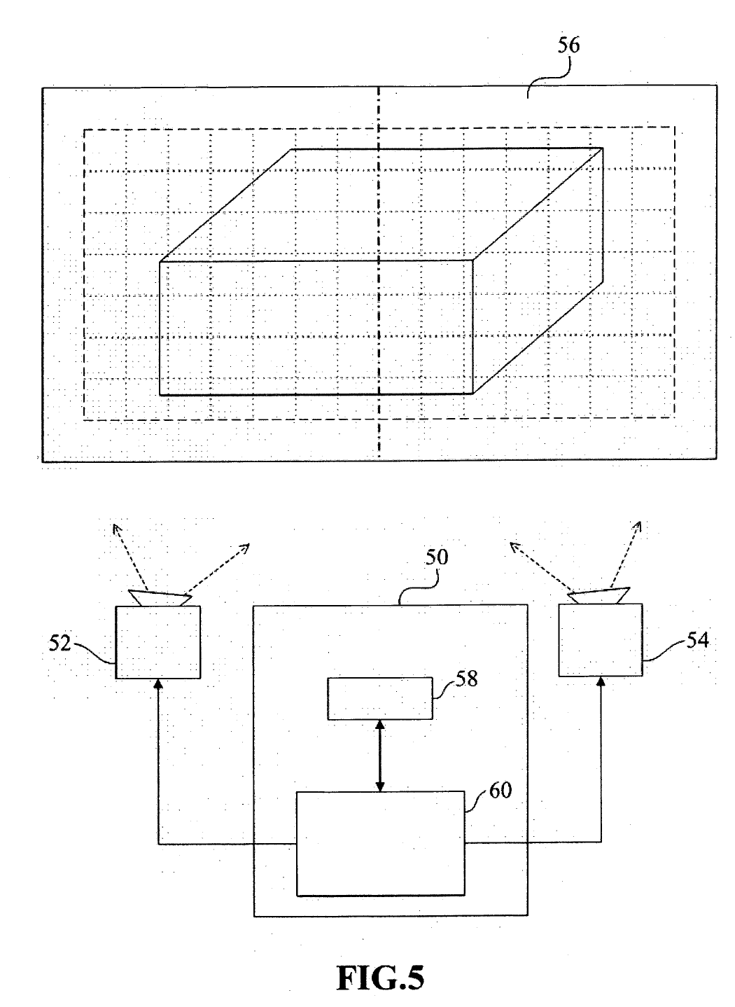

In one embodiment, step S48 also selectively adjusts the positions, the sizes, the keystones, and the brightness of the N sub-images projected onto the screen. Please refer to FIG. 5. FIG. 5 shows the projecting system according to the second preferred embodiment of this invention. The projecting system 50 sends a first sub-image to a first projecting apparatus 52 and a second sub-image to a second projecting apparatus 54. The first projecting apparatus 52 and the second projecting apparatus 54 respectively project the first sub-image and the second sub-image onto the screen as a first projected sub-image and a second projected sub-image.

As shown in FIG. 5, the projecting system 50 includes a sensing device 58 and a processing apparatus 60.

The sensing device 58 senses the first projected sub-image and the second projected sub-image on the screen as a first sensed sub-image and a second sensed sub-image.

The processing apparatus 60 receives an original image and divides the original image into the first sub-image and the second sub-image. The processing apparatus 60 receives the first sensed sub-image and the second sensed sub-image from the sensing device and calculates an alignment difference between the first sensed sub-image and the second sensed sub-image. The processing apparatus 60 also adjusts the first projected sub-image and the second projected sub-image on the screen based on the alignment difference to eliminate the alignment difference.

In one embodiment, the processing apparatus 60 blends the first sub-image with an alignment image and sends the first sub-image blended with the alignment image to the first projecting apparatus 52. The processing apparatus also blends the second sub-image with the alignment image and sends the second sub-image blended with the alignment image to the second projecting apparatus 54.

In one embodiment, the alignment image is a mesh image with a size the same as that of the first sub-image or the second sub-image. In the other embodiment, the alignment image is an edge mark image, and each of the first sub-image and the second sub-image has at least one edge being blended with the edge mark image. In actual applications, the alignment image can also be projected in an invisible ray.

In one embodiment, the first projecting apparatus 52 blends the first sub-image with an alignment image and projects the first sub-image blended with the alignment image, and the second projecting apparatus 54 blends the second sub-image with the alignment image and projects the second sub-image blended with the alignment image.

In one embodiment, the processing apparatus 60 selectively adjusts the positions, the sizes, the keystones and the brightness of the first projected sub-image and the second projected sub-image on the screen 56, respectively.

In one embodiment, the first projecting apparatus 52 and the second projecting apparatus 54 adjust the first projected sub-image and the second projected sub-image in accordance with a plurality of commands transmitted by the processing apparatus 60, respectively. In the other embodiment, the processing apparatus 60 adjusts the first sub-image and the second sub-image, and sends the adjusted first sub-image to the first projecting apparatus 52 and the adjusted second sub-image to the second projecting apparatus 54

If the alignment image is projected onto the screen in an invisible ray which has no effect on the image seen by users, the alignment image can be designed as a simple pattern. Therefore, the projecting system according to this invention only needs a low-resolution sensing device for correctly sensing the alignment images projected on the screen. If the alignment image is designed as a simple pattern, the calculation of alignment differences is also much easier. Thus, the calculation can be speeded up such that the calculating time is saved. Hence, according to the invention, the projecting system doesn't need any high-resolution image sensing device and high-performance processor to provide the function of adjusting the sub-images precisely. The cost and the time for calculation are saved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A projecting system for projecting an image onto a screen divided into N regions, N being an integer larger than 1, said system comprising:
a processing apparatus, for dividing the image into N sub-images;
N projecting apparatuses, for respectively receiving the N sub-images which each corresponds to one of the N regions, each of the projecting apparatuses projecting the received sub-image onto the corresponding region of the screen; and
at least one sensing device, for sensing the projected sub-images and transmitting the sensed sub-images to the processing apparatus;
wherein the processing apparatus further calculates a plurality of alignment differences among the sensed sub-images, and adjusts the projected sub-images on the screen in accordance with the alignment differences to eliminate the alignment differences.

2. The projecting system of claim 1, wherein the processing apparatus further blends each of the sub-images with an alignment image, and outputs the blended sub-images to the N projecting apparatuses.

3. The projecting system of claim 2, wherein the alignment image is a mesh image with a size as the same as that of each of the sub-images.

4. The projecting system of claim 2, wherein the alignment image is an edge mark image, each of the sub-images is at least one edge thereof blended with the edge mark image.

5. The projecting system of claim 1, wherein each of the N projecting apparatuses functions blending the sub-images with an alignment image, and projecting the blended sub-images.

6. The projecting system of claim 5, wherein the alignment image is projected in an invisible ray.

7. The projecting system of claim 1, wherein the processing apparatus selectively adjusts the positions, the sizes, the keystones and the brightness of the projected sub-images projected on the screen.

8. The projecting system of claim 7, wherein the N projecting apparatuses adjusts the projected sub-images in accordance with a plurality of commands asserted by the processing apparatus.

9. The projecting system of claim 7, wherein the processing apparatus adjusts the N sub-images, and sends the adjusted N sub-images to the N projecting apparatuses.

10. A projecting method for projecting an image onto a screen divided into N regions, N being an integer larger than 1, said method comprising the steps of:
(a) dividing the image into N sub-images;
(b) projecting the N sub-images onto the N regions respectively;
(c) sensing the N projected sub-images;
(d) calculating a plurality of alignment differences among the N sensed sub-images and
(e) adjusting the projected sub-images on the screen in accordance with the alignment differences to eliminate the alignment differences.

11. The projecting method of claim 10, wherein step (a) further comprises the step of:
(a1) blending each of the sub-images with an alignment image.

12. The projecting method of claim 11, wherein the alignment image is projected in an invisible ray.

13. The projecting method of claim 10, wherein step (e) further comprises the steps of:
(e1) selectively adjusting the positions, the sizes, the keystones and the brightness of the projected sub-images.

14. A projecting system for sending a first sub-image to a first projecting apparatus and a second sub-image to a second projecting apparatus, the first projecting apparatus and the second projecting apparatus respectively projecting the first sub-image and the second sub-image onto a screen as a first projected sub-image and a second projected sub-image, said system comprising:
a sensing device, for sensing the projected first sub-images and the projected second sub-images as a first sensed sub-image and a second sensed sub-image and
a processing apparatus, for receiving an original image and dividing the original image into the first sub-image and the second sub-image, the processing apparatus receiving the first sensed sub-image and the second sensed sub-image from the sensing device and calculating an alignment difference between the first sensed sub-image and the second sensed sub-image the processing apparatus also adjusting the first projected sub-image and the second projected sub-image on the screen in accordance with the alignment difference to eliminate the alignment difference.

15. The projecting system of claim 14, wherein the processing apparatus blends the first sub-image with an alignment image and sends the first sub-image blended with the alignment image to the first projecting apparatus, and the processing apparatus also blends the second sub-image with the alignment image and sends the second sub-image blended with the alignment image to the second projecting apparatus.

16. The projecting system of claim 15, wherein the alignment image is a mesh image with a size as the same as those of the first sub-image and the second sub-image.

17. The projecting system of claim 15, wherein the alignment image is an edge mark image, each of the first sub-image and the second sub-image is at least one edge thereof blended with the edge mark image.

18. The projecting system of claim 14, wherein the first projecting apparatus blends the first sub-image with an alignment image and projects the first sub-image blended with the alignment image, and the second projecting apparatus blends the second sub-image with the alignment image and projects the second sub-image blended with the alignment image.

19. The projecting system of claim 18, wherein the alignment image is projected in an invisible ray.

20. The projecting system of claim 14, wherein the processing apparatus selectively adjusts the positions, the sizes, the keystones and the brightness of the first projected sub-image and the second projected sub-image on the screen, respectively.

21. The projecting system of claim 20, wherein the first projecting apparatus and the second projecting apparatus adjust the first projected sub-image and the second projected sub-image in accordance with a plurality of commands asserted by the processing apparatus, respectively.

22. The projecting system of claim 20, wherein the processing apparatus adjusts the first sub-image and the second sub-image, and sends the adjusted first sub-image to the first projecting apparatus and the adjusted second sub-image to the second projecting apparatus.
